(19) United States
(12) Patent Application Publication
(10) Pub. No.: US 2020/0038922 A1
(43) Pub. Date: Feb. 6, 2020

(54) DEVICE FOR EXTRACTING TOXIC POWDERS OR VAPOURS AND METHOD FOR IMPLEMENTING SAME

(71) Applicant: OSMOSE, Roquefort Les Pins (FR)

(72) Inventors: Pascal TORRES, Roquefort Les Pins (FR); Pierre URRUTTI, Antibes (FR); Matthieu MARTINS, Grasse (FR)

(73) Assignee: OSMOSE, Roquefort Les Pins (FR)

(21) Appl. No.: 16/603,896

(22) PCT Filed: Apr. 6, 2018
(86) PCT No.: PCT/FR2018/000075

§ 371 Date: Oct. 9, 2019

(30) Foreign Application Priority Data
Apr. 18, 2017 (FR) 1700427

(51) Int. Cl. B08B 15/00

(52) U.S. Cl. CPC B08B 15/007; B08B 2215/003

(57) ABSTRACT

Device for extracting toxic powders or vapours, used with a weighing device on which is placed a container containing products that give off toxic powders or vapours, including a blow nozzle (14) for blowing air to carry toxic vapours to an open top surface of the container and actuated when it is placed facing the container's top surface, and a suction nozzle (16) for sucking up air laden with toxic powders or vapours which has been blown by the blow nozzle, and actuated when it lies facing the open surface of the container, the two nozzles being lowered by a motor (30) to position them facing the container's upper surface. The device includes a safety means for preventing the nozzles from being lowered if there is an unforeseen obstacle underneath one of the nozzles.

### TECHNICAL FIELD OF THE INVENTION

The present invention relates to devices and “push-pull” type processes adapted to extract toxic powders and vapours or other gases and powders during handling operations by an operator performing a weighing operation or equivalent and particularly relates to a device for extracting toxic powders or vapours and the implementation method.

### BACKGROUND ART

In some industrial sectors and particularly in the perfume industry, toxic products such as liquids, e.g. acetone or ammonia, or powders, without forgetting other products whose harmfulness is still poorly known, are regularly handled by the processors.

These products give off toxic powders or vapours which must, therefore, be disposed of so as to preserve the health of the company's employees who would otherwise be regularly exposed to these toxic powders or vapours insofar as, according to the Labour Code, all companies must protect their employees with individual or collective protective equipment. This problem particularly arises in the field of perfumery, and more generally in the chemical industry.

Toxic powders or vapours are extracted using air systems, which are generally extraction hoods such as front hoods, capture arms or pre-perforated ducts.

However, when it comes to weighing products that give off toxic powders or vapours, existing systems have the drawback of having an excessively high extraction rate, which causes disturbances in the weighing process and high energy consumption. Often, the operators prefer to plug these hoods, even switching them off when performing the weighing operation.

A front hood draws in the vapours or the powders which exit containers, giving off toxic powders or vapours through a suction port located behind the containers at a distance that requires the hood to have a high flow rate and at a sufficient height to suck up the powders or vapours released by containers of varying sizes.

With this type of hood, the disturbance on the weighing operation is due to the fact that a high flow rate is required to suck up the maximum amount of toxic powders or vapours and that the extraction rate of powders or vapours, less than 0.5 m/s as recommended, is too low to be efficient. Furthermore, this type of hood consumes a considerable amount of energy because it operates all day long and not just during the weighing operation.

The system using the extraction arms, also referred to as capture arms, allows toxic powders or vapours to be drawn in at the source. However, this system has the same types of drawbacks as the hoods, particularly the need to have an oversized flow rate resulting in high energy consumption. Furthermore, the arms can interfere with the operator's work. In addition, they must be manually positioned by the operator. There is, therefore, no serious guarantee of the operator's protection.

As a result, in order to mitigate the aforementioned drawbacks, and particularly to obtain an air velocity at least equal to 0.5 m/s to capture the gases or powders, the best device is the so-called “push-pull” device in which there is an opening or a blow nozzle to blow air and carry the toxic powders or vapours toward the opening or the suction nozzle, while guaranteeing air velocities at least equal to 0.5 m/s.

Such a “push-pull” device is described in document US2006009147A1. This device is used to extract the toxic vapours at the surface of an open surface container such as a tank containing an electrolyte used in an electrolysis process or for an acid etching process. In this device, the tank being fixed, the blow or suction nozzles or openings are fixed in relation to the tank, and the device operates continuously. Consequently, the device described cannot be used when the container giving off toxic powders or vapours can be of variable height as is the case in the weighing operation and has the major drawback of using a considerable amount of energy since it operates continuously.

A device for the extraction of gas contaminated with or without particles is also known from document DE3723065. This device comprises a nozzle on the side of the contaminated gas source that generates a gas stream that entrains and diverts the contaminated gas toward a device for extracting. Also in this application, the nozzle and the device for extracting are fixed and the device operates continuously.

### DISCLOSURE OF THE INVENTION

This is why the main object of the invention is to supply a device for extracting toxic powders or vapours by blowing-suction, also called “push-pull” extraction, enabling the evacuation of toxic powders or vapours regardless of the size of the container containing products that give off these powders or vapours.

Another object of the invention is to provide a blowing-suction device that operates only when a container containing products that gives off toxic powders or vapours is in place in order to limit energy expenditure.

Yet another object of the invention is to provide a method of extracting toxic powders or vapours by blowing-suction to evacuate the toxic powders or vapours regardless of the size of the container containing products that give off these powders or vapours.

Yet another object of the invention is to provide a method of extracting toxic powders or vapours by blowing-suction enabling the evacuation of toxic powders or vapours automatically without requiring operator action.

Another more specific object of the invention is to provide a device as above in which the container that gives off toxic powders or vapours is placed on a weighing device or an equivalent device.

The main purpose of the invention is thus a device for extracting toxic powders or vapours used with a device for handling products on which is placed a container containing products that give off toxic powders or vapours, the device for extracting comprising a blowing means for blowing air intended to carry the toxic powders or vapours and a suction means for sucking up the air containing the toxic powders or vapours, said blowing and suction means being actuated by a driving means, such as a motor, to raise or lower the blowing and suction means. The product handling device comprises a platform suitable for placing an open, opaque or translucent container of variable size that gives off toxic powders or vapours. The device for extracting is characterized in that:
the air blowing means is a blow nozzle for blowing air onto the open surface of the container, the blowing being actuated when the nozzle is placed facing the open surface,
the suction means is a suction nozzle for sucking up the air laden with toxic powders and vapours which has been blown by the blow nozzle, and suction being actuated when the nozzle lies facing the open surface,
the device for extracting comprises a means of detecting the container placed on the platform of the product handling device, the nozzles being placed at the open top surface of the container in response to the detection means,
the device for extracting further comprises a safety means adapted to stop the nozzle driving means when either or both the nozzles is blocked by an unexpected obstacle.

A second purpose of the invention is a method of extracting toxic powders or vapours implemented in the device above, comprising the following steps:
air is blown by the blow nozzle at the open upper surface of the container placed on the platform of the scale when it is placed facing the open surface, so as to carry the toxic powders or vapours; and
the air laden with toxic powders or vapours is drawn by the suction nozzle when it lies facing the open top surface of the container.

### BRIEF DESCRIPTION OF THE DRAWINGS

Other purposes, objects and characteristics of the invention will become more apparent from the following description when taken in conjunction with the accompanying drawings in which:

FIG. 1 schematically represents the device for extracting toxic powders or vapours used with a weighing device;

FIG. 2 schematically represents the platform of the scale on which is placed a container giving off toxic powders or vapours and the blow and suction nozzles;

FIG. 3A schematically represents the blow nozzle, showing the three air blowing holes and the proximity sensor;

FIG. 3B schematically represents the suction nozzle showing the triangular slot for sucking up the toxic vapours and the reflector;

FIG. 4 schematically represents a front view of the motor and the worm screw used to raise and lower the blow and suction tubes in a preferred embodiment;

FIG. 5A schematically represents a side view of the interdependent assembly of the worm screw and the blow and suction tubes when there is no unexpected obstacle preventing tubes from descending;

FIG. 5B schematically represents a side view of the interdependent assembly of the worm screw and the blow and suction tubes that are no longer interdependent when there is an unexpected obstacle preventing tubes from descending;

FIG. 6 schematically represents a particular embodiment of the blow and suction nozzles; and

FIG. 7 schematically represents a particular embodiment of the blow nozzle.

### DETAILED DESCRIPTION OF THE INVENTION

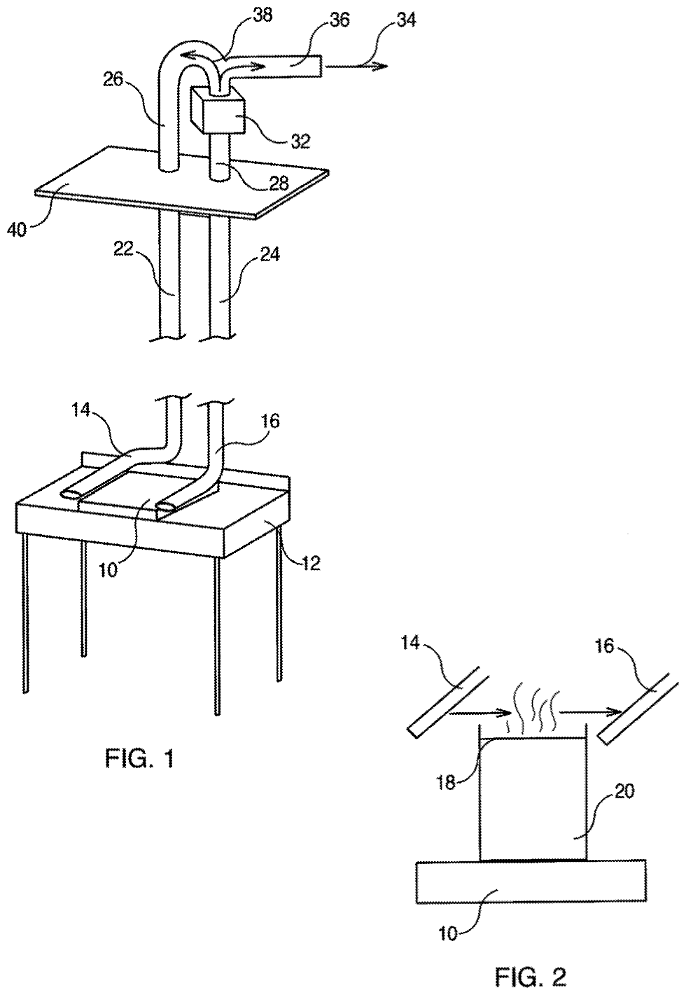

In reference to FIG. 1, a device for extracting toxic powders or vapours according to the invention is used with a weighing device comprising a scale 10 placed on a table 12. During a weighing operation, the operator places a container containing products giving off toxic powders or vapours on the platform of the scale 10. It should be noted that the container (not shown) can have any size, and be opaque or translucent.

The “push-pull” device for extracting comprises two nozzles, a blow nozzle 14 and a suction nozzle 16. The blow nozzle 14 blows air in order to carry the toxic powders or vapours which are drawn by the suction nozzle 16.

As shown schematically in FIG. 2, the blow nozzle 14 and the suction nozzle 16 are placed on either side of the open surface 18 of a container 20 placed on the platform of the scale 10. The air is blown by the blow nozzle 14 and the air carrying the toxic powders or vapours is drawn in by the suction nozzle 16.

In the device for extracting illustrated in FIG. 1, the blow nozzles 14 and suction nozzles 16 are located at the end of air tubes 22 and 24, respectively. Tubes 22 and 24 open in the ducts, ducts 26 and 28, respectively. The raising or lowering of the tubes is actuated by actuating means which is generally a motor.

The air blown by the tube 22 and the blow nozzle 14 come from an appropriate blowing means and the air carrying the toxic powders or vapours in the suction nozzle 16 and the tube 24 is drawn by an appropriate suction means. In the preferred embodiment of the invention, the blowing and suction means can be combined into a single built-in fan 32.

It should be noted that the fan 32 can be placed above a false ceiling 40 so as to limit noise disturbances. Furthermore, valves (not shown) are placed on the part of the tubes located above the false ceiling 40 in order to adjust the desired flow rates.

When in operation, this fan draws the air laden with vapours upwards. The flow of air is thus divided into two parts. A first part 34 is discharged to the outlet 36 of the duct 28 while a second part 38 is sent downward toward the bottom of the tube 22 and the blow nozzle 14. It should be noted that, by means of the valves mentioned above, part 38, sent into the tube 22 and blown by the blow nozzle 14, is lesser than the part 34 discharged to the outlet, and preferably represents 5% of the air laden with toxic vapours received by the tube 24.

This ingenious means further improves the energy efficiency of the system by taking the supply air from the exhaust air, thereby reducing the amount of exhaust air.

It should be noted that the fan is preferably of EC technology (electronically commutated, with very low energy consumption), which makes it possible to integrate the device into all air systems, even those initially not designed to connect extraction equipment. The fan limits the overall exhaust airflow rate as the supply air is taken from the exhaust air.

In the case of powders and not toxic vapours, the air blown by the blow nozzle 14 does not come from the air extracted by the nozzle 16 but from new air drawn into the room. In this case, the device comprises two fans: a first fan to blow air into the nozzle 14 and a second fan to extract air by the nozzle 16.

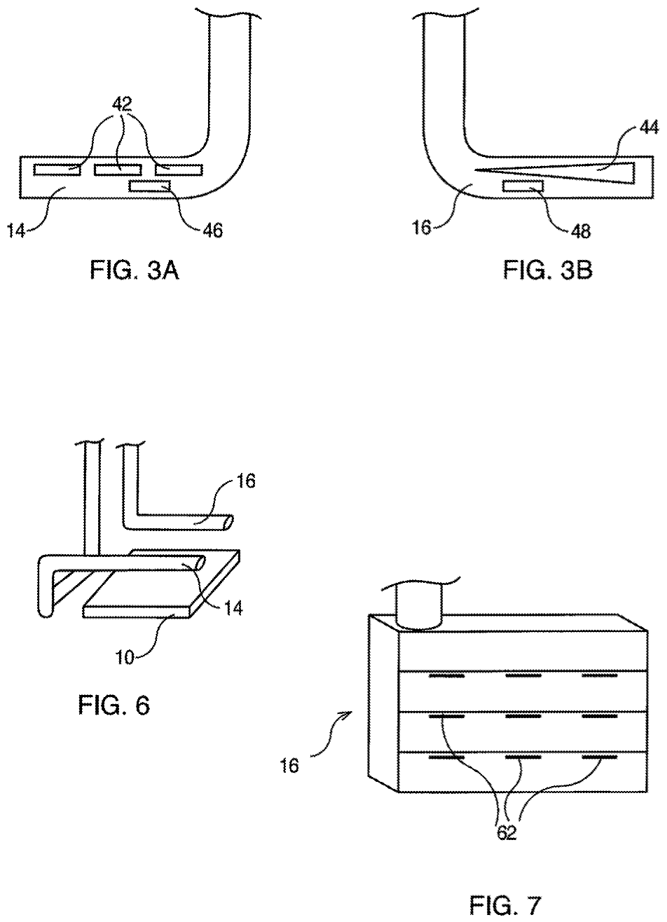

As illustrated in FIG. 3A, the blow nozzle 14 comprises openings, e.g. slots 42 as illustrated in the figure, to allow a horizontal laminar airflow to pass, oriented toward the open surface 18 of the container 20, as was described in reference to FIG. 2. These slots have a height of 1 mm and extend over a length of 200 mm. These slots are framed inside the blow tube by 4 polyamide faces of a depth of 10 mm, thereby allowing a laminar airflow to be produced at the exit of the nozzle. It should be noted that the blow openings through which the air passes could have any other shape.

As illustrated in FIG. 3B, the suction nozzle 16 features a slot 44 adapted to receive the flow of air and powders or vapours. The slot 44 has a notably triangular shape such that the flow of the air entering the suction nozzle is the same regardless the distance from the elbow of the tube 24 located upstream from the suction nozzle.

In reference to FIG. 3A, the blow nozzle 14 features a proximity sensor 46 placed under the holes 42, and the suction nozzle 16 illustrated in FIG. 3B, comprises a reflector 48 placed under the slot 44. The proximity sensor 46 transmits an electromagnetic signal, preferably an infrared signal, that is reflected by the reflector 48. When the operator places a container on the platform of the scale, the nozzles are in low position at the scale, as will be shown later, and therefore the container blocks the signal transmitted by the proximity sensor 46. This signal is thus not reflected by the reflector 48 received back by the proximity sensor 46. The device for extracting therefore knows that a container has just been placed on the platform of the scale.

It should be noted that the proximity sensor 46 and reflector 48 assembly can be replaced by any equivalent means and particularly an ultrasound detector instead of an infrared detector. When the container is placed on the platform of the scale, the ultrasound signal is sent to the detector, which allows the detector to know the reduced distance separating it from the container and thus to determine that a container has just been placed.

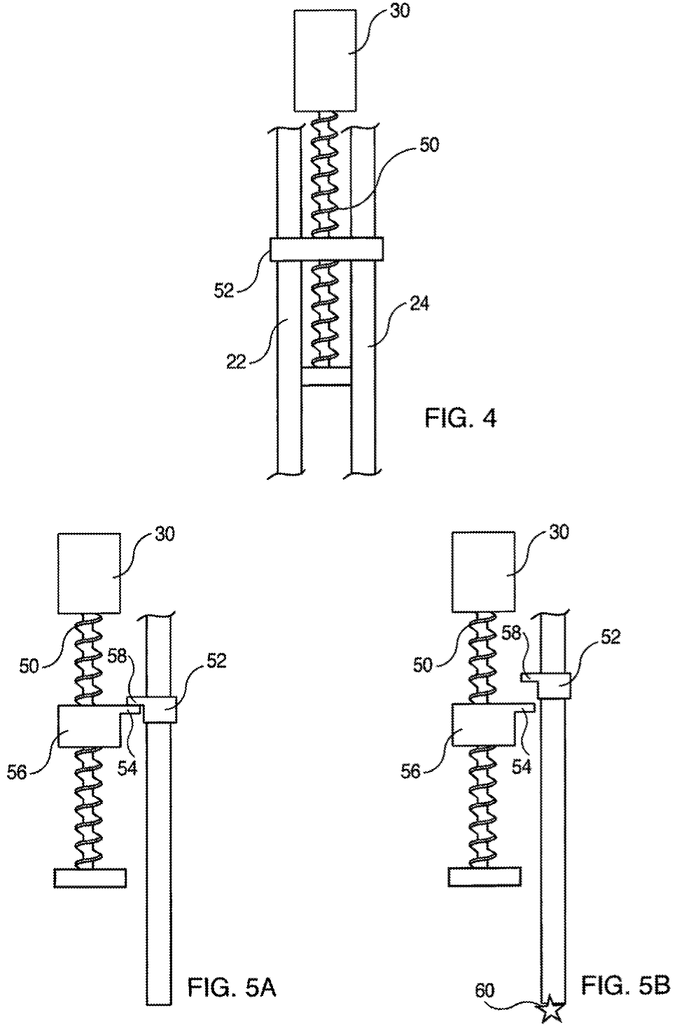

As illustrated in FIG. 4, the means for actuating the air tubes is a motor 30 that is preferably a direct current motor or a stepper motor equipped with a worm screw 50 integral with a fastener 52 that actuates the tubes 22 and 24. The start-up of the motor 30 drives the worm screw 50 in rotation and causes the fastener 52 to raise or lower. It should be noted that instead of the worm screw 50, a winch can be used, the cable of which is guided by pulleys to raise and lower tubes 22 and 24, or even a belt that is guided and driven by pulleys to also ensure the lowering or raising of the tubes 22 and 24.

As illustrated in figures SA and SB, the device for actuating tubes comprises a perfected mechanism preventing the tubes from descending further before encountering an obstacle, such an obstacle could be the container 20, which is poorly positioned, or the operator's hand. To do this, the fastener 52 consists of a magnet 54 which is secured with a ring 56, itself secured to the worm screw 50. The fastener 52 secured on the air tubes comprises a steel element 58 which magnetically bonded to the magnet 54. Thus, when the worm screw is actuated, it drives the tubes 22 and 24 and the nozzles 14 and 16 up or down with the magnet 54. If an unexpected obstacle 60 blocks either of said nozzles during their descent, the nozzles cannot descend any further. Immediately, the steel element 58 ceases to be magnetically bonded to the magnet 54 because a resistance greater than a force defined due to the magnet is applied. A contact sensor (not shown) located on the magnet 54 sends a signal to reverse the direction of rotation of the motor in order to raise the blow and suction tubes to a high safety position and to allow the operator to stop this incident by removing the obstacle 60. The normal cycle will resume only after voluntary action by the operator. To do this, a push-button type actuator, not shown in the diagrams, is built into the side of the blow nozzle 14. After actuation of the button by the user, the tubes 22 and 24 reposition themselves in low position.

The safety means described above is intended to protect the user and the equipment. It is faster and more reliable than detecting an increase in motor intensity. It even allows the motor to be uncoupled from the tubes and thus prevents crushing should the automated system fail.

FIG. 6 represents a particular embodiment in which the blow nozzles 14 and suction nozzles 16 are not placed on the sides of the platform 10 of the product handling device but at the front and rear of the platform because handling operations are easier for some operators.

FIG. 7 represents a particular embodiment in which the suction nozzle 16 is rectangular in shape and taller, allowing it to capture peripheral vapours owing to slots 62 located over the entire height in the event that these vapours are released by a second bottle held in the operator's hand.

The connection with the components illustrated in the figures, the method of extracting toxic powders or vapours according to the invention is as follows. Firstly, after powering up and when no container has been placed on the weighing platform 10, the device is in stand-by mode. The motor 30 lowers the tubes 22 and 24 to the low position, i.e. with nozzles 14 and 16 at the platform of the scale, until the low limit switch is actuated.

When the container is placed on the platform scale, the proximity sensor 46 detects its presence. When the container is detected for a predetermined time, e.g. for more than 2 seconds, the device switches to positioning mode.

In positioning mode, the motor 30 raises the tubes 22 and 24, and the nozzles 14 and 16 at the same time, until the sensor 46 no longer detects the presence of the container, which means that the nozzles are placed just above the level of the open surface of the container. The motor 30 then lowers the tubes until the container is detected again by the sensor 46.

As soon as the container is detected (for the second time), the motor stops and the fan is switched on. For this purpose, the fan 32 is switched on. The operator can now conduct the weighing operation safely since the toxic powders or vapours are extracted by the tube 24. The suction flow in the tube 24 is adjusted once and for all by a potentiometer, and the blowing flow rate in the tube 22 is adjusted by a blowing valve.

When the operator removes the container at the end of the weighing operation, the sensor 46 detects the absence of a container and, after a predetermined time, e.g. 2 seconds, it lowers the tubes 22, 24 and the nozzles 14, 16 to the lower position.

A high limit switch and a low limit switch (not shown) are located at the ends of the worm screw 50. The motor is thus switched off when the upper and low limit switches are detected. In order to prevent an obstacle on the up or down stroke of the tubes 22, 24 from causing an increase in current intensity in the motor, a current intensity sensor and a fuse are placed on the motor start so as to detect overconsumption and cause the motor 30 to stop before it is damaged.

It should be noted that the operator must be informed immediately of no suction in the tube 24 if it is obstructed. To do this, a pressure sensor in the tube measures the pressure difference with the atmospheric pressure. The operator is notified if the pressure difference exceeds a certain threshold. This allows the operator to know, at all times, whether the fan is in working order and can apply the appropriate safety procedure defined in this case.

The operation of the motor 30 is controlled by PLC which integrates a program taking into account the information received by the various detectors and sensors mentioned above. It should be noted that this PLC can be connected to a wireless WIFI type network or by Ethernet cable in order to be able to receive information on the energy performance characteristics of the device, but also on the status of the various sensors and actuators in order to conduct remote diagnosis in the event of a malfunction. Several machines can be connected to a centralised supervision system that records all states and reports alarms in case of malfunction.

In addition, a special maintenance mode allows the blow nozzles 14 and suction nozzles 16 to be raised to the upper position in order to allow maintenance operations, for example, on the scale or cleaning operations without disrupting the user. In this mode, bottle detection is deactivated and the fan is shut off. This mode is controlled by a push-button type actuator placed on the side of the blow nozzle 14 and not represented in the diagrams.

The device and the method of extracting toxic powders or vapours described above are particularly adapted in the field of perfumery where the raw materials used to compose perfumes are more harmful than one may think. Various varieties of chemicals, most often toxic such as acetone, are indeed handled by operators on a daily basis. Furthermore, there still exists products for which the risks are still not well known to date.

It should be noted that the device described above can be adapted to be installed in an explosive atmosphere zone (ATEX).

The method of extracting toxic powders or vapours described above can be used in all types of air systems, including those with low available pressures such as controlled mechanical ventilation.

Although the invention has been described in the case of a weighing operation on a scale of products giving off toxic powders and vapours, it is self evident that it could be applied to any equivalent device comprising a platform on which an operator places a container intended to be handled by an operator.

1. A device for extracting toxic powders or vapours used with a device for handling products on which is placed a container containing products that give off toxic powders or vapours, said device for extracting comprising
a blowing means for blowing air intended to carry the toxic powders or vapours and a suction means for sucking up the air containing the toxic powders or vapours, said blowing and suction means being actuated by a driving means, such as a motor (30), to raise or lower the blowing and suction means;
said product handling device (10) comprising a platform suitable for placing an open, opaque or translucent container (20) of variable size that gives off toxic powders or vapours,
characterized in that said air blowing means is a blow nozzle (14) to blow air at the open surface of said container, and blowing is actuated when said nozzle is placed facing said open surface,
said suction means is a suction nozzle (16) for sucking up the air laden with toxic powders and vapours which has been blown by said blow nozzle, and suction is actuated when said nozzle lies facing said open surface,
said device for extracting comprises a means for detecting (46, 48) said container placed on the platform of said product handling device, said nozzles being placed at the open upper surface of said container in response to said detection means, and
said device for extracting further comprises a safety means suitable to stop said nozzle driving means (30) when either of said nozzles is blocked by an unexpected obstacle.

2. The device for extracting according to claim 1, wherein said driving means (30) is integral with a worm screw (50) comprising a ring (56) and said nozzles comprise a fastener (52), said safety means comprising a magnet (54) fastened on said ring, a contact detector fastened to said magnet and a steel element (58) magnetically bonded to said magnet which renders said element integral with said worm screw, said steel element being unbonded from said magnet when either of said nozzles is blocked by an unexpected object and said contact detector sending a signal allowing the operator to stop this incident by removing the obstacle.

3. The device for extracting according to claim 1, wherein said product handling device (10) is a weighing device.

4. The device for extracting according to claim 1, wherein said blow nozzle (14) comprises one or several openings, e.g. slots (42 or 62), suitable to blow air on the open top surface of said container and thus carry the toxic powders or vapours toward said suction nozzle (16).

5. The device for extracting according to claim 1, wherein said suction nozzle (16) comprises a slot (44) intended to receive the airflow and vapours or powders from said blow nozzle (14), said slot having a suitable shape so that the flow of air entering the suction nozzle is the same regardless of the distance in relation to the elbow of the suction tube (24) located upstream.

6. The device for extracting according to claim 4, wherein said detection means consists of a proximity sensor (46) located under said openings (42) of said blow nozzle (14) and a reflector (48) located under the slot (44) of said suction nozzle (16), said proximity sensor being suited to transmit an electromagnetic signal, preferably an infra-red signal, in such a way that said signal is reflected by said reflector if no container is placed on the platform of said product handling device (10) or if the air is blown by said blow nozzle at the open surface of a container placed on said platform or is blocked and not reflected if a container has just been placed on the platform.

7. The device for extracting adapted for the extraction of toxic powders according to claim 1, further comprising a fan (32) placed at the top of the suction tube (24), said fan being adapted to extract by said suction nozzle a significant part (34) of the air laden with toxic vapours toward the outlet (36) and to send a less significant part (38) of this air toward the blow tube (22) and to blow it by said blow nozzle (14).

8. The device for extracting adapted for the extraction of toxic powders according to claim 1, further comprising a first fan to blow air into said blow nozzle (14) and a second fan to extract the air laden with toxic powders by said suction nozzle (16).

9. The device for extracting according to claim 1, wherein said motor (30) is a stepper or direct current motor adapted to cause the rotation of a worm screw (50) when started, said worm screw being integral at its lower part with a crossmember (52) fastened at its ends to the blow tube (22) and suction tube (24), the raising and lowering of said crossmember driving the raising and lowering of said tubes.

10. The device for extracting according to claim 1, wherein said motor (30) comprises a winch, the cable of which, guided by pulleys, is adapted to drive the raising and lowering of said blow tube (22) and suction tube (24) when said motor is started.

11. The device for extracting according to claim 1, wherein a current intensity sensor is installed on said motor (30) so as to detect overconsumption and cause said motor to stop before it is damaged if an obstacle on the up or down stroke of the tubes (22, 24) causing an increase in current intensity in the motor.

12. The device for extracting according to claim 1, wherein a pressure sensor is placed in said suction tube (24) to measure the pressure difference with the atmospheric pressure, so that the operator is informed if this pressure difference exceeds a certain threshold.

13. The device for extracting according to claim 1, wherein a push-button is built into the side of the blow nozzle (14), the actuation of said button by the operator allowing the tubes (22 and 24) to reposition themselves in low position, the normal cycle resuming only after voluntary action by the operator.

14. A method of extracting toxic powders and vapours implemented in the device of claim 1, comprising the following steps:
air is blown by said blow nozzle (14) at the open surface of the container placed on the platform of said product handling device (10) when it is placed facing the open top surface of a container, so as to carry the toxic powders or vapours; and
the air, laden with toxic powders and vapours, is sucked in by said suction nozzle (16) when it lies facing said open surface.

15. The method of extracting toxic powders or vapours according to claim 14, wherein, when no container is placed on the platform of said product handling device (10) and when the device is in stand-by mode, the motor (30) lowers the blow nozzle (14) and suction nozzle (16) to the level of said platform.

16. The method of extracting toxic powders or vapours according to claim 15, wherein, when the proximity sensor detects the presence of a container that has just been placed on the platform of said product handling device (10) for a predetermined time, e.g. 2 seconds, the motor (30) raises the tubes (22, 24), and at the same time the nozzles (14, 16), until the detection means (46, 48) no longer detects the presence of the container, which means that the nozzles are placed just above the level of the open surface of the container.

17. The method of extracting toxic powders or vapours according to claim 16, wherein the motor (30) lowers the tubes (22, 24) until said detection means (46, 48) detects the container once again.

18. The method of extracting toxic powders or vapours according to claim 17, wherein, as soon as the container is detected (for the second time), the motor (30) stops and the fan (32) starts so that the toxic powders or vapours are sucked in by said suction nozzle (16) and the suction tube (24).

19. The method of extracting toxic powders or vapours according to claim 18, wherein, when the container is removed at the end of the weighing operation, the detection means (46, 48) detects the absence of a container and, after a predetermined time, e.g. 2 seconds, it lowers the tubes (22, 24) and the nozzles (14, 16) to low position.

20. The method of extracting toxic powders or vapours according to claim 19, used with all types of air systems, including those with low available pressures such as controlled mechanical ventilation.
